(19) United States
(12) Patent Application Publication
(10) Pub. No.: US 2016/0277628 A1
(43) Pub. Date: Sep. 22, 2016

(54) INFORMATION PROCESSING APPARATUS, INFORMATION PROCESSSING SYSTEM, AND NON-TRANSITORY COMPUTER READABLE MEDIUM

(71) Applicant: FUJI XEROX CO., LTD., Tokyo (JP)

(72) Inventor: Nobutaka KATO, Kanagawa (JP)

(73) Assignee: FUJI XEROX CO., LTD., Tokyo (JP)

(21) Appl. No.: 14/796,276

(22) Filed: Jul. 10, 2015

(30) Foreign Application Priority Data
Mar. 19, 2015 (JP) 2015-055818

(51) Int. Cl. H04N 1/32; H04N 1/00

(52) U.S. Cl. CPC H04N 1/32085; H04N 1/00217; H04N 1/32368; H04N 1/0097; H04N 2201/0094

(57) ABSTRACT

An information processing apparatus includes a memory, a transmitting unit, and a deleting unit. The memory stores document data. The transmitting unit is capable of transmitting the document data and first specifying data to an external apparatus. The document data is stored in the memory. The first specifying data is data for specifying the document data. The deleting unit deletes the document data from the memory when information indicating that the first specifying data matches second specifying data is received from the external apparatus. The second specifying data is data for specifying the document data received by the external apparatus. When communication using HTTP is performed in the transmission of the document data to the external apparatus, the transmitting unit transmits the first specifying data to the external apparatus.

### CROSS-REFERENCE TO RELATED APPLICATIONS

This application is based on and claims priority under 35 USC 119 from Japanese Patent Application No. 2015-055818 filed Mar. 19, 2015.

### BACKGROUND

### Technical Field

The present invention relates to an information processing apparatus, an information processing system, and a non-transitory computer readable medium.

### SUMMARY

According to an aspect of the invention, there is provided an information processing apparatus including a memory, a transmitting unit, and a deleting unit. The memory stores document data. The transmitting unit is capable of transmitting the document data and first specifying data to an external apparatus. The document data is stored in the memory. The first specifying data is data for specifying the document data. The deleting unit deletes the document data from the memory when information indicating that the first specifying data matches second specifying data is received from the external apparatus. The second specifying data is data for specifying the document data received by the external apparatus. When communication using HTTP is performed in the transmission of the document data to the external apparatus, the transmitting unit transmits the first specifying data to the external apparatus.

### BRIEF DESCRIPTION OF THE DRAWINGS

Exemplary embodiment of the present invention will be described in detail based on the following figures, wherein:

FIG. 1 is a block diagram illustrating an image forming system according to an exemplary embodiment of the present invention;

FIG. 2 is a block diagram illustrating an image forming apparatus according to the exemplary embodiment;

FIG. 3 is a block diagram illustrating a terminal apparatus;

FIG. 4 is a flowchart of an exemplary process according to a first example;

FIG. 5 is a flowchart of an exemplary process according to a second example;

FIG. 6 is a flowchart of an exemplary process according to a third example;

FIG. 7 is a flowchart of an exemplary process according to a fourth example; and

FIG. 8 is a flowchart of an exemplary process according to a fifth example.

### DETAILED DESCRIPTION

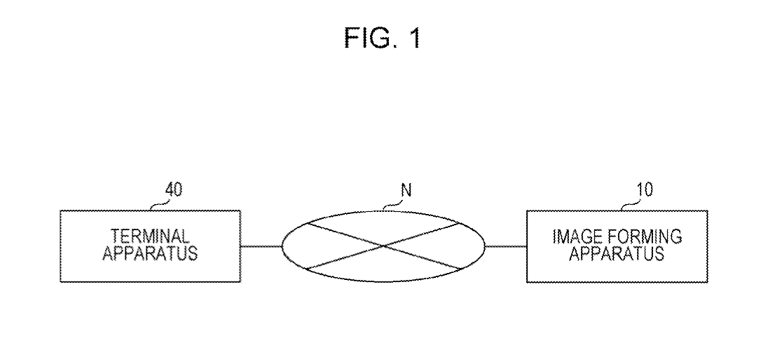

FIG. 1 illustrates an exemplary image forming system serving as an information processing system according to an exemplary embodiment of the present invention. For example, the image forming system includes an image forming apparatus 10 serving as an information processing apparatus and a terminal apparatus 40 serving as an external apparatus. The image forming apparatus 10 and the terminal apparatus 40 are connected to a communication path N. The communication path N is constituted, for example, by a network such as the Internet. In FIG. 1, one image forming apparatus 10 is included in the image forming system. This is merely an example. Multiple image forming apparatuses 10 may be included in the image forming system. Multiple terminal apparatuses 40 may be connected to the communication path N. Servers, such as a print server and an image server, may be connected to the communication path N.

The image forming apparatus 10 is provided with a scan function (image reading function) and a function of transmitting, to another apparatus, document data generated through scanning. The document data may encompass image data. The image forming apparatus 10 may be provided with at least one of a print function, a copy function, and a facsimile function, as a function other than the scan function.

The terminal apparatus 40 which is an apparatus, such as a personal computer (PC), a tablet PC, a smartphone, or a cellular phone, is provided with a function of receiving/transmitting data from/to another apparatus.

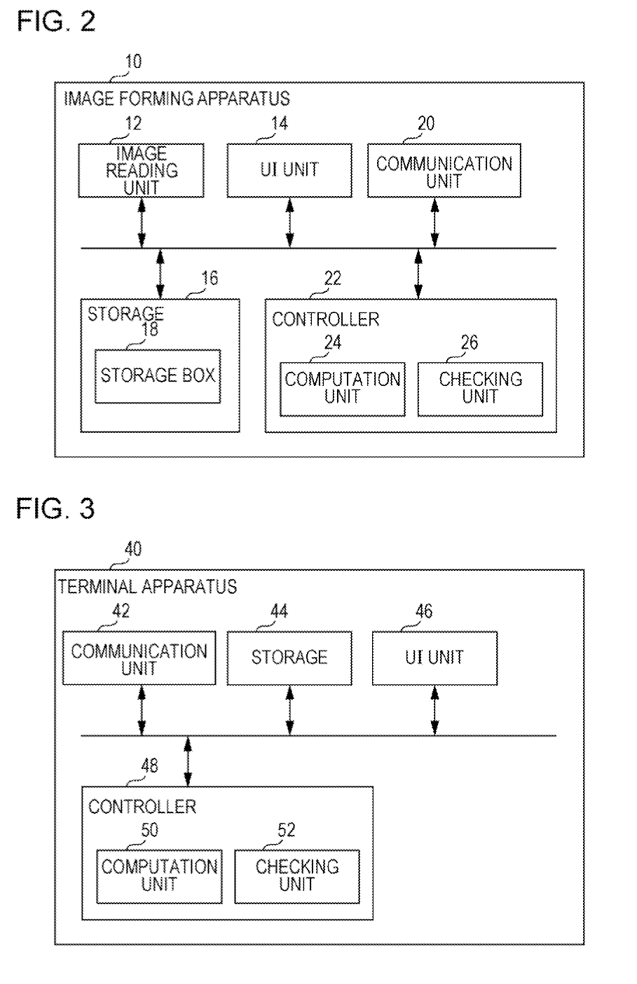

FIG. 2 illustrates the configuration of the image forming apparatus 10. An image reading unit 12 generates document data by scanning (reading) a document. A user interface (UI) unit 14 which is a user interface includes a display and an operation unit. The display is a display apparatus such as a liquid-crystal display. The operation unit is an input apparatus such as an operation panel.

A storage 16 is a storage apparatus such as a hard disk. In the storage 16, a storage box 18 is created. The storage box 18 is a specific storage area in which document data is stored, and is, for example, a storage area on the storage apparatus such as a hard disk. In the storage 16, one or more storage boxes 18 are created. Each storage box 18 is associated with box information (such as the box ID, the box number, or the box name) for identifying the storage box 18. As an application, it is assumed that the name of a user himself/herself (the full name or the family name) is used as the box information. For example, when a user specifies a storage box 18 as a storage target for document data, document data generated by the image reading unit 12 is stored in the specified storage box 18. One or more storage boxes 18 may be created for each user, or a shared storage box 18 may be created. In addition, attribute information (such as information indicating the file size, the date and time of creation, or the like) of document data is stored in the storage 16 in such a manner as to be associated with the document data.

A communication unit 20 is a communication interface connected to the communication path N. The communication unit 20 is provided with a function of receiving data from another apparatus and a function of transmitting data to another apparatus. For example, the communication unit 20 is provided with a function of transmitting document data stored in a storage box 18, to the terminal apparatus 40.

A controller 22 controls operations of the units of the image forming apparatus 10. For example, the controller 22 controls scanning performed by the image reading unit 12. The controller 22 causes various types of information to be displayed on the display of the UI unit 14. The controller 22 stores document data in a storage box 18 specified by a user. When a user gives an instruction to create a new storage box 18, the controller 22 generates a new storage box 18 and associates box information with the storage box 18. The controller 22 may associate authentication information (a user ID and a password) with a storage box 18. An operation of specifying a storage box 18 which is a storage target for box information and document data, an operation of giving an instruction to create a new storage box 18, and an operation of inputting authentication information are performed, for example, by a user using the terminal apparatus 40 or the UI unit 14.

The controller 22 includes a computation unit 24 and a checking unit 26. The computation unit 24 generates first check data from document data generated by the image reading unit 12. The first check data is used as data for determining whether or not download of document data is successfully completed. Examples of the first check data include information indicating the file size of document data and the checksum value of document data. The first check data is stored in the storage 16 in such a manner as to be associated with the document data. The first check data corresponds to first specifying data, and is data for specifying the document data.

The checking unit 26 checks the first check data generated by the computation unit 24 against second check data obtained from document data which has been transmitted to the terminal apparatus 40. Examples of the second check data also include information indicating the file size of document data and the checksum value of document data. The second check data corresponds to second specifying data, and data for specifying the document data. When the checking operation is successfully performed (for example, when the first check data matches the second check data or when it is confirmed that the first check data corresponds to the second check data), the controller 22 deletes the document data from the storage 16. The processes performed by the checking unit 26 will be described in detail below.

The image forming apparatus 10 may include an authentication unit that performs user authentication. For example, the storage 16 stores authentication information (for example, a user ID and a password). The authentication unit performs authentication on the basis of authentication information received from the UI unit 14 and the authentication information stored in the storage 16. When authentication is successfully performed (for example, when both of the pieces of authentication information match each other), use of the image forming apparatus 10 is permitted. An authentication card in which the authentication information is recorded may be used. In this case, a card reading apparatus connected to the image forming apparatus 10 reads information in the authentication card, whereby the image forming apparatus 10 receives the authentication information.

In accordance with the authentication result, access to the storage box 18 may be permitted. For example, authentication information is associated in advance with each storage box 18. On the terminal apparatus 40, a storage box 18 is specified, and authentication information is input. The box information indicating the specified storage box 18 and the authentication information are transmitted from the terminal apparatus 40 to the image forming apparatus 10. The authentication unit of the image forming apparatus 10 performs authentication on the basis of the authentication information transmitted from the terminal apparatus 40 and the authentication information associated with the storage box 18. When the authentication is successfully performed, the authentication unit permits access to the specified storage box 18 from the terminal apparatus 40.

The authentication information may be stored in an authentication server which performs authentication. In this case, no authentication information may be stored in the storage 16. Needless to say, no user authentication may be performed in the present exemplary embodiment.

FIG. 3 illustrates the configuration of the terminal apparatus 40. A communication unit 42 is a communication interface connected to the communication path N. The communication unit 42 is provided with a function of receiving data from another apparatus and a function of transmitting data to another apparatus. For example, the communication unit 42 is provided with a function of accessing a storage box 18 in the image forming apparatus 10 and receiving document data stored in the storage box 18 (a so-called download function). A storage 44 is a storage apparatus such as a hard disk. The storage 44 stores a document acquisition program (plug-in application) for accessing a storage box 18 and acquiring stored data, and a program for a Web browser. A UI unit 46 which is a user interface includes a display and an operation unit. The display is a display apparatus such as a liquid-crystal display. The operation unit is an input apparatus, such as a keyboard a mouse, or a touch panel.

A controller 48 controls operations of the units of the terminal apparatus 40. The controller 48 includes a computation unit 50 and a checking unit 52. The computation unit 50 generates the second check data (data corresponding to the second specifying data) from document data which has been transmitted from the image forming apparatus 10. That is, the computation unit 50 computes the file size of the document data or the checksum value of the document data. The checking unit 52 checks the first check data transmitted from the image forming apparatus 10 against the second check data generated by the computation unit 50. When the checking process is successfully performed (for example, when the first check data matches the second check data, or when it is confirmed that the first check data corresponds to the second check data), the controller 48 transmits information (delete command) indicating an instruction to delete the document data, to the image forming apparatus 10. In this case, the controller 22 in the image forming apparatus 10 deletes the document data from the storage 16. The delete command may be created by the controller 22, or may be created in advance. The functions of the computation unit 50 and the checking unit 52 may be implemented by using the above-described document acquisition program, or may be implemented by using another program. The processes performed by the checking unit 52 will be described in detail below.

In the present exemplary embodiment, when the document acquisition application is performed in the terminal apparatus 40, document data is downloaded by using a Web browser from the image forming apparatus 10 to the terminal apparatus 40. As the download system, a communication system, for example, using Hypertext Transfer Protocol (HTTP) is employed. It is assumed that this communication system has a specification in which a command indicating that the entire document data has been downloaded (command indicating completion of transmission of document data or completion of reception of the document data) is not transmitted between the image forming apparatus 10 and the terminal apparatus 40.

Examples of a communication protocol other than HTTP include server message block (SMB) protocol and file transfer protocol (FTP). In download systems using these communication protocols, when download is successfully performed, a command indicating completion of the download is transmitted between the image forming apparatus 10 and the terminal apparatus 40. In this case, the controller 22 of the image forming apparatus 10 detects completion of download of document data by using the command, and deletes the document data from the storage 16.

When the document acquisition application is performed in the terminal apparatus 40, a selection screen for selecting a storage box is displayed on the display of the UI unit 46. On the selection screen, a user uses the operation unit of the UI unit 46 to select a target storage box 18, or to input the box information (for example, the box number N) of the target storage box 18. The user uses the operation unit of the UI unit 46 to select document data A which is a download target and to give an instruction to download the document data. Thus, the document data specified by the user is transmitted from the image forming apparatus 10 to the terminal apparatus 40.

When multiple image forming apparatuses 10 are connected to the communication path N, the user may specify an image forming apparatus 10 storing document data which is a download target, on the terminal apparatus 40. For example, device identification information (for example, device names or Internet Protocol (IP) addresses) for identifying individual image forming apparatuses 10 is displayed on the display of the terminal apparatus 40, and a selection screen for the storage boxes created in an image forming apparatus 10 specified by the user is displayed on the display.

Specific examples will be described below.

### First Example

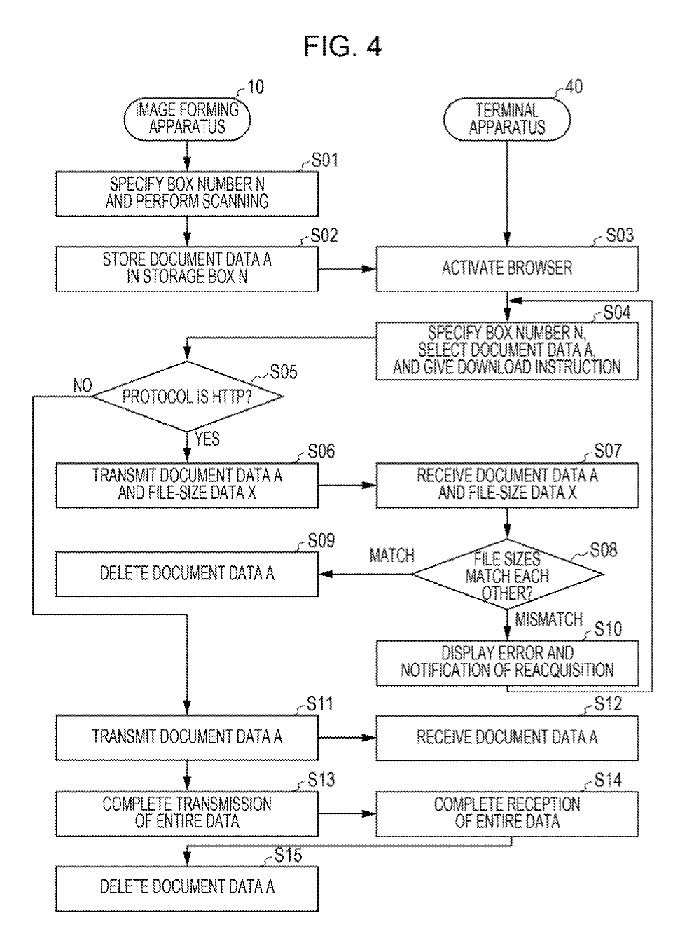

By referring to FIG. 4, processes according to a first example will be described. In the first example, file-size data is used as check data (specifying data), and the checking process is performed in the terminal apparatus 40.

A user uses the operation unit of the UI unit 14 of the image forming apparatus 10 to specify the box number N of a storage box which is a storage target for document data and to give an instruction to perform scanning (S01). Thus, the image reading unit 12 reads a document to generate document data A. In the image forming apparatus 10, the controller 22 stores the document data A in the storage box of the box number N (hereinafter referred to as a “storage box N”) which is created in the storage 16 (S02). When the storage box N has been already created, the document data A is stored in the storage box N. When the storage box N has not been created, the controller 22 creates a new storage box N, and the document data A is stored in the storage box N.

Then, the user uses the terminal apparatus 40 to activate a Web browser, and activates the document acquisition software as a plug-in application (S03). Subsequent processes are performed by the Web browser and the document acquisition software. For example, when the IP address of the image forming apparatus 10 is specified, the Web browser uses the communication unit 42 to access the image forming apparatus 10. In addition, by executing the document acquisition software, the box information of the storage boxes created in the image forming apparatus 10 is obtained, and the selection screen for the storage boxes is displayed on the display of the UT unit 46 of the terminal apparatus 40. The user uses the operation unit of the UI unit 46 to specify the target storage box N, to specify the document data A stored in the storage box N, and to give an instruction to perform download (S04). Thus, download instruction information indicating an instruction to download the document data A is transmitted from the terminal apparatus 40 to the image forming apparatus 10. In the image forming apparatus 10, it is determined whether or not the communication protocol used for the download is HTTP (S05). This determination is performed by the controller 22 of the image forming apparatus 10. If the communication protocol is HTTP (YES in step S05), the process proceeds to step S06. In step S06, the controller 22 of the image forming apparatus 10 obtains the document data A and file-size data X (attribute information) indicating the file size of the document data A from the storage box N, and uses the communication unit 20 to transmit the document data A and the file-size data X to the terminal apparatus 40. The file-size data X is computed, for example, by the computation unit 24. In the terminal apparatus 40, the document acquisition software is executed, whereby the document data A and the file-size data X are received (S07). The document data A and the file-size data X are stored in the storage 44 of the terminal apparatus 40.

In the terminal apparatus 40, the computation unit 50 computes file-size data Y of the received document data A, and the checking unit 52 compares the file-size data X transmitted from the image forming apparatus 10 with the file-size data Y of the received document data A (S08). If the file size X matches the file size Y (MATCH in step S08), the controller 48 of the terminal apparatus 40 creates a delete command to delete the document data A, and uses the communication unit 42 to transmit the delete command to the image forming apparatus 10. Upon reception of the delete command, the controller 22 of the image forming apparatus 10 deletes the document data A from the storage 16 (storage box N) (S09). If the file size X matches the file size Y, it is confirmed that the document data A before the transmission is the same as that after the reception. That is, the download of the document data A is successfully completed. In this case, the document data A is deleted. If the file size X does not match the file size Y (MISMATCH in step S08), the controller 48 of the terminal apparatus 40 causes error information and notification information for supplying a notification of reacquisition of the document data to be displayed on the display of the UI unit 46 (S10). Either one of the error information and the notification information may be displayed. Then, the process returns back to step S04. If the file size X does not match the file size Y, it is confirmed that the document data A before the transmission is not the same as that after the reception. That is, the download of the document data A is not successfully completed. In this case, the document data A is not deleted from the image forming apparatus 10.

If the download instruction supplied from the terminal apparatus 40 does not satisfy the condition in step S05 (NO in step S05), the process proceeds to step S11. That is, when the communication protocol used in the download is a communication protocol other than HTTP, the process proceeds to step S11. In step S11, the controller 22 of the image forming apparatus 10 obtains the document data A from the storage box N, and uses the communication unit 20 to start transmission of the document data A to the terminal apparatus 40. The terminal apparatus 40 receives the document data A (S12). In the image forming apparatus 10, upon completion of transmission of the entire document data A, the controller 22 of the image forming apparatus 10 transmits information (transmission-completion command) indicating completion of the transmission, to the terminal apparatus 40 (S13). In the terminal apparatus 40, upon completion of reception of the entire document data A, the controller 48 of the terminal apparatus 40 transmits information (reception-completion command) indicating completion of the reception, to the image forming apparatus 10 (S14). Upon reception of the reception-completion command, the controller 22 of the image forming apparatus 10 deletes the document data A from the storage 16 (storage box N) (S15).

As described above, according to the first example, the file size of document data is used to detect normal completion of download of the document data even when a command indicating completion of transmission/reception of document data (that is, a command indicating completion of download) is not used. Then, the document data is deleted from the image forming apparatus 10. For example, even when HTTP is employed as the communication protocol, completion of download is detected, and the document data is then deleted from the image forming apparatus 10. The document data is automatically deleted. Therefore, a user does not need to delete the document data from the image forming apparatus 10 manually. In addition, increase in a consumption of the storage capacity of the storage 16 is suppressed.

In step S05, it may be determined whether or not the download instruction is supplied from the document acquisition software (plug-in application). In accordance with the determination result, the process may proceed to step S06 or step S11. For example, if the communication protocol for the download is HTTP and if the download instruction is supplied from the document acquisition software (YES in step S05), the process may proceed to step S06. If the communication protocol for the download is a communication protocol other than HTTP or if the download instruction is not supplied from the document acquisition software (NO in step S05), the process may proceed to step S11. As described above, the functions of the computation unit 50 and the checking unit 52 of the terminal apparatus 40 may be implemented by using the document acquisition software. In this case, when the download instruction supplied from the terminal apparatus 40 is not supplied from the document acquisition software, it is assumed that the document acquisition software is not stored in the terminal apparatus 40 and that the comparison process in step S08 is not performed. Therefore, when the download instruction is not supplied from the document acquisition software, the process proceeds to step S11. Needless to say, regardless of whether or not the document acquisition software is stored in the terminal apparatus 40, when the communication protocol for the download is HTTP, the document data A and the file-size data X may be transmitted to the terminal apparatus 40.

When automatic deletion of document data is set, the process of determining a protocol (S05), the process of transmitting file-size data X, and the process of deleting document data (S09 or S15) may be performed. Thus, when automatic deletion is not necessary, these processes are skipped. Setting of automatic deletion is performed, for example, by a user using the UI unit 14 of the image forming apparatus 10. The user may set automatic deletion by using the UI unit 46 of the terminal apparatus 40. In this case, the setting information is transmitted from the terminal apparatus 40 to the image forming apparatus 10, and the controller 22 of the image forming apparatus 10, for example, deletes the document data in accordance with the setting information.

When an instruction to download the document data A is given by a user in step S04, the controller 48 of the terminal apparatus 40 may transmit terminal identification information (for example, a client ID) for identifying the terminal apparatus 40, along with the download instruction information to the image forming apparatus 10. In this case, the controller 22 of the image forming apparatus 10 associates the terminal identification information with the document data A stored in the storage 16. In step S08, if the file size X matches the file size Y (YES in step S08), the controller 48 of the terminal apparatus 40 transmits the terminal identification information along with the delete command to delete the document data A, to the image forming apparatus 10. When the terminal identification information transmitted along with the delete command matches the terminal identification information associated with the document data A, the controller 22 deletes the document data A from the storage 16. Thus, the terminal identification information is used to improve security for the document data A which is a target to be deleted.

In the first example, the checking unit 26 of the image forming apparatus 10 does not perform any process. Therefore, the checking unit 26 does not need to be provided for the image forming apparatus 10.

### Second Example

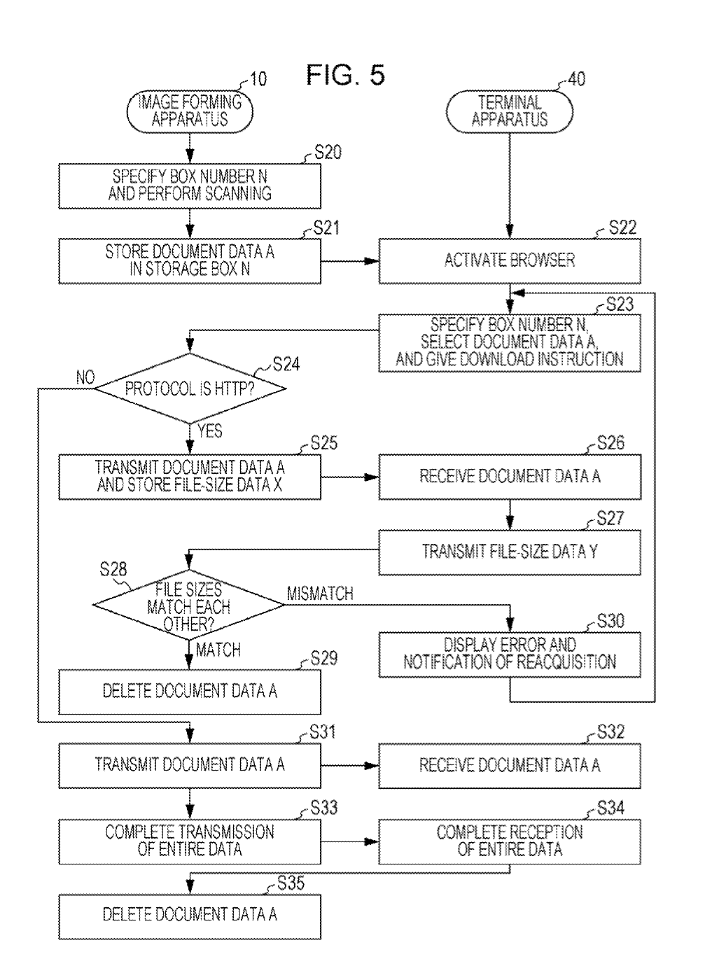

Referring to FIG. 5, processes according to a second example will be described. In the second example, file size data is used as the check data (specifying data), and the checking process is performed in the image forming apparatus 10.

Similarly to the first example, in the image forming apparatus 10, a user specifies a box number N, and gives an instruction to perform scanning (S20). Thus, a document is read to generate document data A which is stored in the storage box N in the storage 16 (S21).

In the terminal apparatus 40, a Web browser and the document acquisition software are activated (S22), and the user specifies the storage box N and the document data A, and then gives a download instruction (S23). Thus, download instruction information indicating an instruction to download the document data A is transmitted from the terminal apparatus 40 to the image forming apparatus 10. If the communication protocol for the download is HTTP (YES in step S24), the process proceeds to step S25. In step S25, the controller 22 of the image forming apparatus 10 obtains the document data A from the storage box N, transmits it to the terminal apparatus 40, and stores the file-size data X of the document data A in the storage 16 (S25). The file-size data X is computed, for example, by the computation unit 24. The terminal apparatus 40 receives the document data A (S26). The document data A is stored in the storage 44 of the terminal apparatus 40.

In the terminal apparatus 40, the computation unit 50 computes the file-size data Y of the received document data A, and the controller 48 uses the communication unit 42 to transmit the file-size data Y to the image forming apparatus 10 (S27). The file-size data Y is received by the communication unit 20 of the image forming apparatus 10. In the image forming apparatus 10, the checking unit 26 compares the file-size data X stored in the storage 16 with the file-size data Y transmitted from the terminal apparatus 40 (S28). If the file size X matches the file size Y (MATCH in step S28), the controller 22 of the image forming apparatus 10 deletes the document data A from the storage 16 (storage box N) (S29). If the file size X does not match the file size Y (MISMATCH in step S28), the controller 22 uses the communication unit 20 to transmit comparison result information indicating that both of the file sizes do not match each other, to the terminal apparatus 40. In the terminal apparatus 40, upon reception of the comparison result information, the controller 48 causes error information and notification information for supplying a notification of reacquisition of the document data to be displayed on the display of the UI unit 46 (S30). Then, the process returns back to step S23.

If the download instruction supplied from the terminal apparatus 40 does not satisfy the condition in step S24 (NO in step 624), the process proceeds to step S31. The processes in steps S31 to 635 are the same as those in steps S11 to S15 according to the first example, and will not be described.

As described above, similarly to the first example, normal completion of download of document data is detected according to the second example. Then, the document data is deleted from the image forming apparatus 10.

Also in the second example, similarly to the first example, it may be determined whether or not the download instruction is supplied from the document acquisition software, in step S24. In accordance with the determination result, the process may proceed to step S25 or step S31. When automatic deletion of document data is set, the process of determining a protocol (S24), the process of storing the file-size data X, and the process of deleting the document data (S29 or S35) may be performed. The terminal identification information of the terminal apparatus 40 may be transmitted to the image forming apparatus 10. In this case, the terminal identification information of the terminal apparatus 40 is transmitted along with the download instruction information from the terminal apparatus 40 to the image forming apparatus 10, and the terminal identification information is associated with the document data A. The terminal identification information is transmitted along with the file-size data Y from the terminal apparatus 40 to the image forming apparatus 10. If the file-size data X matches the file size Y and if the transmitted terminal identification information matches the terminal identification information associated with the document data A, the document data A is deleted from the storage 16.

In the second example, the checking unit 52 of the terminal apparatus 40 does not perform any process. Therefore, the checking unit 52 does not need to be provided for the terminal apparatus 40.

In both of the first example and the second example, the file-size data is used to detect completion of download. In the first example, the terminal apparatus 40 does not need to transmit the file-size data Y to the image forming apparatus 10. Therefore, compared with the second example, transfer risk (for example, damage of the file-size data Y due to a communication failure) for the file-size data Y is reduced in the first example, achieving higher reliability of the check data.

### Third Example

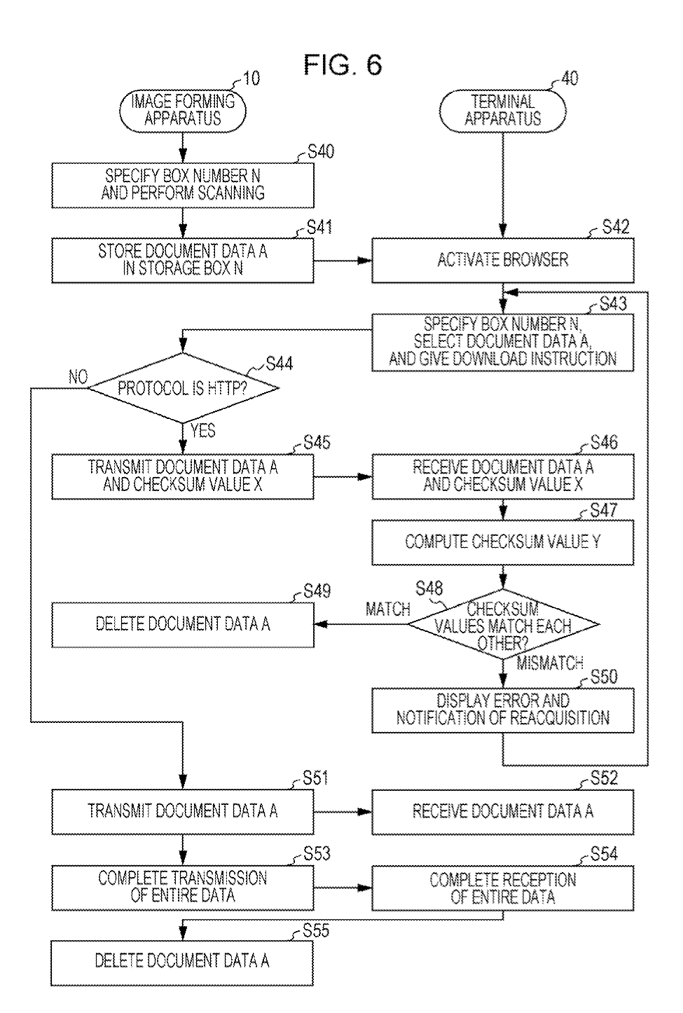

Referring to FIG. 6, processes according to a third example will be described. In the third example, checksum value data is used as the check data (specifying data), and the checking process is performed in the terminal apparatus 40.

Similarly to the first example, in the image forming apparatus 10, a user specifies a box number N, and gives an instruction to perform scanning (S40). Thus, a document is read to generate document data A which is stored in the storage box N in the storage 16 (S41).

In the terminal apparatus 40, a Web browser and the document acquisition software are activated (S42), and the user specifies the storage box N and the document data A, and then gives a download instruction (S43). Thus, download instruction information indicating an instruction to download the document data A is transmitted from the terminal apparatus 40 to the image forming apparatus 10. If the communication protocol for the download is HTTP (YES in step S44), the process proceeds to step S45. In step S45, the controller 22 of the image forming apparatus 10 obtains the document data A from the storage box N, and uses the communication unit 20 to transmit the document data A and the checksum value X to the terminal apparatus 40. The checksum value X is computed from the document data A by the computation unit 24. The terminal apparatus 40 receives the document data A and the checksum value X (S46). The document data A and the checksum value X are stored in the storage 44 of the terminal apparatus 40.

The computation unit 50 of the terminal apparatus 40 computes a checksum value Y from the received document data A (S47). The checking unit 52 of the terminal apparatus 40 compares the checksum value X transmitted from the image forming apparatus 10 with the checksum value Y obtained from the received document data A (S48). If the checksum value X matches the checksum value Y (MATCH in step S48), the controller 48 of the terminal apparatus 40 uses the communication unit 42 to transmit a delete command to delete the document data A to the image forming apparatus 10. Upon reception of the delete command, the controller 22 of the image forming apparatus 10 deletes the document data A from the storage 16 (storage box N) (S49). If the checksum value X matches the checksum value Y, it is confirmed that the document data A before the transmission is the same as that after the reception. That is, the download of the document data A is successfully completed. In this case, the document data A is deleted. If the checksum value X does not match the checksum value Y (MISMATCH in step S48), the controller 48 of the terminal apparatus 40 causes error information and notification information for supplying a notification of reacquisition of the document data to be displayed on the display of the UI unit 46 (S50). Then, the process proceeds to step S43. If the checksum value X does not match the checksum value Y, it is confirmed that the document data A before the transmission is not the same as that after the reception. That is, the download of the document data A is not successfully completed. In this case, the document data A is not deleted from the image forming apparatus 10.

If the download instruction supplied from the terminal apparatus 40 does not satisfy the condition in step S44 (NO in step S44), the process proceeds to step S51. The processes in steps S51 to S55 are the same as those in steps S11 to S15 according to the first example, and will not be described.

As described above, in the third example, by using checksum value data, even when a command indicating completion of download of document data is not used, normal completion of download of document data is detected. Then, the document data is deleted from the image forming apparatus 10. Detection of completion of download using checksum value data causes accuracy of the detection to be improved compared with the case using file-size data.

Also in the third example, similarly to the first example, it may be determined whether or not the download instruction is supplied from the document acquisition software, in step S44. In accordance with the determination result, the process may proceed to step S45 or step S51. When automatic deletion of document data is set, the process of determining a protocol (S44), the process of transmitting the checksum value X, and the process of deleting the document data (S49 or S55) may be performed. The terminal identification information of the terminal apparatus 40 may be transmitted to the image forming apparatus 10. In this case, the terminal identification information of the terminal apparatus 40 is transmitted along with the download instruction information from the terminal apparatus 40 to the image forming apparatus 10, and the terminal identification information is associated with the document data A. The terminal identification information is transmitted along with the delete command from the terminal apparatus 40 to the image forming apparatus 10. If the transmitted terminal identification information matches the terminal identification information associated with the document data A, the document data A is deleted from the storage 16.

In the third example, the checking unit 26 of the image forming apparatus 10 does not perform any process. Therefore, the checking unit 26 does not need to be provided for the image forming apparatus 10.

### Fourth Example

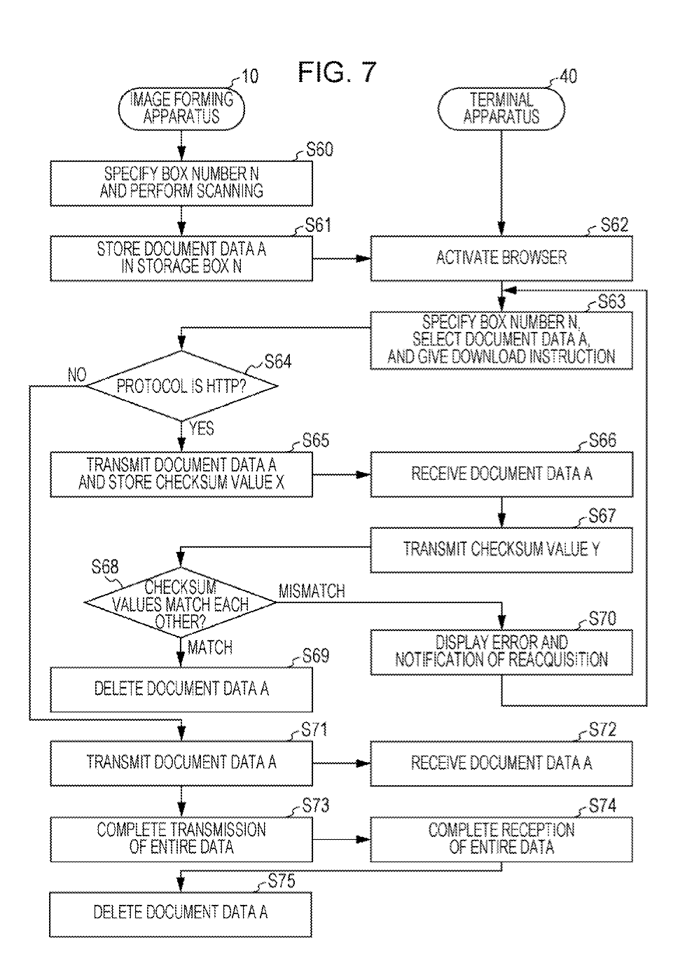

Referring to FIG. 7, processes according to a fourth example will be described. In the fourth example, checksum value data is used as the check data (specifying data), and the checking process is performed in the image forming apparatus 10.

Similarly to the first example, in the image forming apparatus 10, a user specifies a box number N, and gives an instruction to perform scanning (S60). Thus, a document is read to generate document data A which is stored in the storage box N in the storage 16 (S61).

In the terminal apparatus 40, a Web browser and the document acquisition software are activated (S62), and the user specifies the storage box N and the document data A, and then gives a download instruction (S63). Thus, download instruction information indicating an instruction to download the document data A is transmitted from the terminal apparatus 40 to the image forming apparatus 10. If the communication protocol for the download is HTTP (YES in step S64), the process proceeds to step S65. In step S65, the controller 22 of the image forming apparatus 10 obtains the document data A from the storage box N, transmits the document data A to the terminal apparatus 40, and stores the checksum value X of the document data A in the storage 16 (S65). The checksum value X is computed from the document data A by the computation unit 24. The terminal apparatus 40 receives the document data A (S66). The document data A is stored in the storage 44 of the terminal apparatus 40.

In the terminal apparatus 40, the computation unit 50 computes the checksum value Y from the received document data A, and the controller 48 uses the communication unit 42 to transmit the checksum value Y to the image forming apparatus 10 (S67). The checksum value Y is received by the communication unit 20 of the image forming apparatus 10. In the image forming apparatus 10, the checking unit 26 compares the checksum value X stored in the storage 16 with the checksum value Y transmitted from the terminal apparatus 40 (S68). If the checksum value X matches the checksum value Y (MATCH in step S68), the controller 22 of the image forming apparatus 10 deletes the document data A from the storage 16 (storage box N) (S69). If the checksum value X does not match the checksum value Y (MISMATCH in step S68), the controller 22 uses the communication unit 20 to transmit comparison result information indicating that both of the checksum values do not match each other, to the terminal apparatus 40. In the terminal apparatus 40, upon reception of the comparison result information, the controller 48 causes error information and notification information for supplying a notification of reacquisition of the document data to be displayed on the display of the UI unit 46 (S70). Then, the process returns back to step S63.

If the download instruction supplied from the terminal apparatus 40 does not satisfy the condition in step S64 (NO in step S64), the process proceeds to step S71. The processes in steps S71 to S75 are the same as those in steps S11 to S15 according to the first example, and will not be described.

As described above, similarly to the third example, normal completion of download of document data is detected according to the fourth example. Then, the document data is deleted from the image forming apparatus 10.

Also in the fourth example, similarly to the first example, it may be determined whether or not the download instruction is supplied from the document acquisition software, in step S64. In accordance with the determination result, the process may proceed to step S65 or step S71. When automatic deletion of document data is set, the process of determining a protocol (S64), the process of storing the checksum value X, and the process of deleting the document data (S69 or S75) may be performed. The terminal identification information of the terminal apparatus 40 may be transmitted to the image forming apparatus 10. In this case, the terminal identification information of the terminal apparatus 40 is transmitted along with the download instruction information from the terminal apparatus 40 to the image forming apparatus 10, and the terminal identification information is associated with the document data A. The terminal identification information is transmitted along with the checksum value Y from the terminal apparatus 40 to the image forming apparatus 10. If the checksum value X matches the checksum value Y and if the transmitted terminal identification information matches the terminal identification information associated with the document data A, the document data A is deleted from the storage 16.

In the fourth example, the checking unit 52 of the terminal apparatus 40 does not perform any process. Therefore, the checking unit 52 does not need to be provided for the terminal apparatus 40.

In both of the third example and the fourth example, the checksum value data is used to detect completion of download. In the third example, the terminal apparatus 40 does not need to transmit the checksum value Y to the image forming apparatus 10. Therefore, in the third example, compared with the fourth example, transfer risk (for example, damage of the checksum value Y due to a communication failure) for the checksum value Y is reduced, achieving higher reliability of the check data.

### Fifth Example

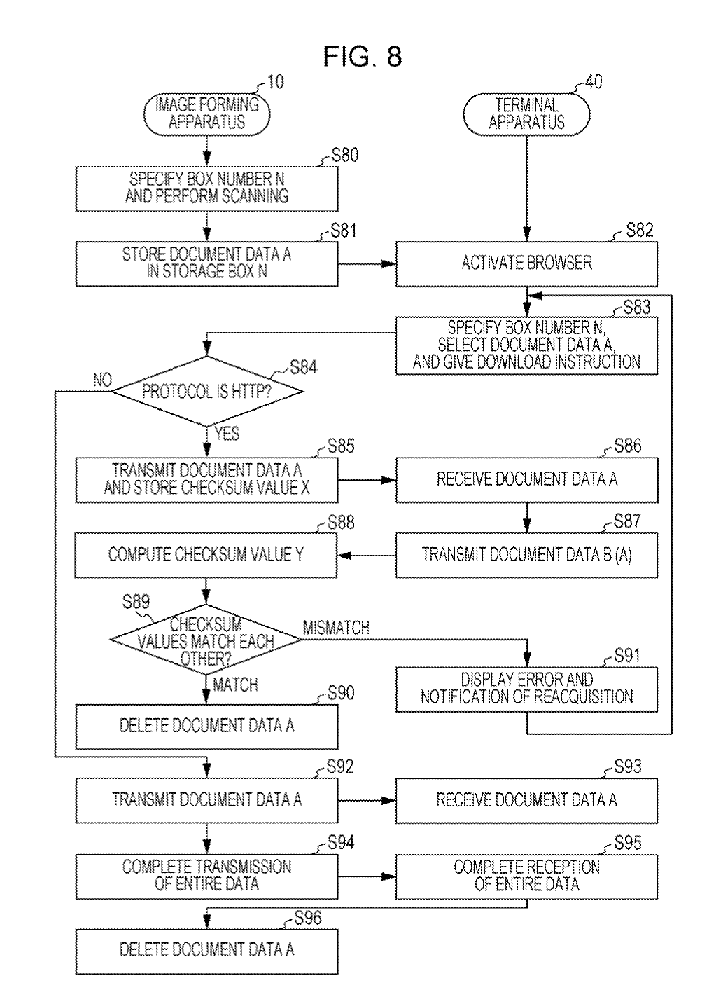

Referring to FIG. 8, processes according to a fifth example will be described. In the fifth example, checksum value data is used as the check data (specifying data), and the checking process is performed in the image forming apparatus 10.

Similarly to the first example, in the image forming apparatus 10, a user specifies a box number N, and gives an instruction to perform scanning (S80). Thus, a document is read to generate document data A which is stored in the storage box N in the storage 16 (S81).

In the terminal apparatus 40, a Web browser and the document acquisition software are activated (S82), and the user specifies the storage box N and the document data A, and then gives a download instruction (S83). Thus, download instruction information indicating an instruction to download the document data A is transmitted from the terminal apparatus 40 to the image forming apparatus 10. If the communication protocol for the download is HTTP (YES in step S84), the process proceeds to step S85. In step S85, the controller 22 of the image forming apparatus 10 obtains the document data A from the storage box N, transmits it to the terminal apparatus 40, and stores the checksum value X of the document data A in the storage 16 (S85). The checksum value X is computed from the document data A by the computation unit 24. The terminal apparatus 40 receives the document data A (S86). The document data A is stored in the storage 44 of the terminal apparatus 40.

In the terminal apparatus 40, the controller 48 uses the communication unit 42 to transmit the received document data A to the image forming apparatus 10 (S87). Hereinafter, the document data A transmitted from the terminal apparatus 40 to the image forming apparatus 10 is referred to as document data B in order to differentiate it from the document data A transmitted from the image forming apparatus 10 to the terminal apparatus 40. The document data B is received by the communication unit 20 of the image forming apparatus 10. In the image forming apparatus 10, the computation unit 24 computes the checksum value Y from the document data B (S88), and the checking unit 26 compares the checksum value X stored in the storage 16 (the checksum value computed from document data A) with the checksum value Y computed from the document data B (S89). If the checksum value X matches the checksum value Y (MATCH in step S89), the controller 22 of the image forming apparatus 10 deletes the document data A from the storage 16 (storage box N) (S90). If the checksum value X does not match the checksum value Y (MISMATCH in step S89), the controller 22 uses the communication unit 20 to transmit comparison result information indicating that both of the checksum values do not match each other, to the terminal apparatus 40. In the terminal apparatus 40, upon reception of the comparison result information, the controller 48 causes error information and notification information for supplying a notification of reacquisition of the document data to be displayed on the display of the UI unit 46 (S91). Then, the process returns back to step S83.

If the download instruction supplied from the terminal apparatus 40 does not satisfy the condition in step S84 (NO in step S84), the process proceeds to step S92. The processes in steps S92 to S96 are the same as those in steps S11 to S15 according to the first example, and will not be described.

As described above, in the fifth example, by using document data uploaded from the terminal apparatus 40 to the image forming apparatus 10, even when a command indicating completion of download of document data is not used, normal completion of download of document data is detected. Then, the document data is deleted from the image forming apparatus 10.

In the above-described fifth example, checksum value data is used as check data. Alternatively, the file sizes of the document data A and B may be used. In this case, in the image forming apparatus 10, the computation unit 24 computes the file sizes X and Y of the document data A and B, and the checking unit 26 compares the file size X with the file size Y. If the file size X matches the file size Y, the document data A is deleted from the image forming apparatus 10. Alternatively, the checking unit 26 may compare the document data A itself with the document data B itself. If the document data A matches the document data B, the document data A is deleted from the image forming apparatus 10.

When the checking process is completed in the image forming apparatus 10, the controller 22 deletes the document data B from the image forming apparatus 10.

Also in the fifth example, similarly to the first example, it may be determined whether or not the download instruction is supplied from the document acquisition software, in step S84. In accordance with the determination result, the process may proceed to step S85 or step S92. When automatic deletion of document data is set, the process of determining a protocol (S84), the process of storing the checksum value X, and the process of deleting the document data (S90 or S96) may be performed. The terminal identification information of the terminal apparatus 40 may be transmitted to the image forming apparatus 10. In this case, the terminal identification information of the terminal apparatus 40 is transmitted along with the download instruction information from the terminal apparatus 40 to the image forming apparatus 10, and the terminal identification information is associated with the document data A. The terminal identification information is transmitted along with the document data B from the terminal apparatus 40 to the image forming apparatus 10. If the check data of the document data A matches that of the document data B and if the transmitted terminal identification information matches the terminal identification information associated with the document data A, the document data A is deleted from the storage 16.

In the fifth example, the computation unit 50 and the checking unit 52 of the terminal apparatus 40 do not perform any process. Therefore, the computation unit 50 and the checking unit 52 do not need to be provided for the terminal apparatus 40.

In the above-described first to fifth examples, the image forming apparatus 10 or the terminal apparatus 40 performs the checking process. The checking process may be performed by another apparatus such as a server. In this case, the first and second check data are transmitted from the image forming apparatus 10 and the terminal apparatus 40 to the apparatus such as a server, and the checking process is performed in the apparatus. Information indicating the checking result is transmitted from the apparatus such as a server to the image forming apparatus 10, and the controller 22 of the image forming apparatus 10 deletes the document data from the storage 16 in accordance with the checking result. Thus, even when the apparatus such as a server is used, normal completion of download of document data is detected.

The above-described image forming apparatus 10 is implemented, for example, through cooperation of hardware resources and software. Specifically, the image forming apparatus 10 includes a processor (not illustrated) such as a central processing unit (CPU). The processor reads out programs stored in a storage apparatus (not illustrated) and executes them, achieving the functions of the units of the image forming apparatus 10. The above-described programs are stored in the storage apparatus via a recording medium, such as a compact disc (CD) or a digital versatile disc (DVD), or via a communication unit such as a network. The units of the image forming apparatus 10 may be implemented by using hardware resources, such as a processor and electronic circuits. In this implementation, devices such as a memory may be used. As another example, the units of the image forming apparatus 10 may be implemented by using a digital signal processor (DSP), a field programmable gate array (FPGA), or the like.

The terminal apparatus 40 is implemented, for example, through cooperation of hardware resources and software. Specifically, the terminal apparatus 40 includes a processor (not illustrated) such as a CPU. The processor reads out programs stored in a storage apparatus (not illustrated) and executes them, achieving the functions of the units of the terminal apparatus 40. The above-described programs are stored in the storage apparatus via a recording medium, such as a CD or a DVD, or via a communication unit such as a network. The units of the terminal apparatus 40 may be implemented by using hardware resources, such as a processor and electronic circuits. In this implementation, devices such as a memory may be used. As another example, the units of the terminal apparatus 40 may be implemented by using a DSP, an FPGA, or the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores document data;
a transmitting unit that is capable of transmitting the document data and first specifying data to an external apparatus, the document data being stored in the memory, the first specifying data being data for specifying the document data; and
a deleting unit that deletes the document data from the memory when information indicating that the first specifying data matches second specifying data is received from the external apparatus, the second specifying data being data for specifying the document data received by the external apparatus,
wherein, when communication using HTTP is performed in the transmission of the document data to the external apparatus, the transmitting unit transmits the first specifying data to the external apparatus.

2. The information processing apparatus according to claim 1,
wherein the deleting unit obtains the document data which has been transmitted to the external apparatus, from the external apparatus, and, when the second specifying data for specifying the obtained document data matches the first specifying data, deletes the document data from the memory.

3. The information processing apparatus according to claim 1,
wherein, only when an automatic deletion command for the document data is set, the first specifying data and the second specifying data are computed.

4. An information processing system comprising:
an information processing apparatus; and
a terminal apparatus,
wherein the information processing apparatus includes
a memory that stores document data,
a first transmitting unit that is capable of transmitting the document data and first specifying data to the terminal apparatus, the document data being stored in the memory, the first specifying data being data for specifying the document data, and
a deleting unit that deletes the document data from the memory when information indicating that the first specifying data matches second specifying data is received from the terminal apparatus, the second specifying data being data for specifying the document data received by the terminal apparatus, the information being made from comparison between the first specifying data and the second specifying data, and
wherein, when communication using HTTP is performed in the transmission of the document data to the terminal apparatus, the first transmitting unit transmits the first specifying data to the terminal apparatus.

5. The information processing system according to claim 4,
wherein the terminal apparatus includes
a receiving unit that receives the document data and the first specifying data from the information processing apparatus, and
a second transmitting unit that, when the second specifying data matches the first specifying data, transmits deletion instruction information to the information processing apparatus, the second specifying data being obtained from the document data received by the receiving unit, the deletion instruction information indicating an instruction to delete the document data, and
wherein, upon reception of the deletion instruction information, the deleting unit deletes the document data from the memory.

6. The information processing system according to claim 4,
wherein the terminal apparatus further includes
a display controller that causes a display to display at least one of error information and reacquisition notification information for reacquiring the document data, in accordance with the comparison result.

7. The information processing system according to claim 4,
wherein the information processing apparatus further includes
a determining unit that, only when an automatic deletion command for the document data is set, determines whether or not the document data is transmitted in a communication using HTTP, and
wherein, when the determining unit determines that the communication using HTTP is performed, the first transmitting unit transmits the document data and the first specifying data to the terminal apparatus.

8. A non-transitory computer readable medium storing a program causing a computer to execute a process comprising:
transmitting document data and first specifying data to an external apparatus, the document data being stored in a memory, the first specifying data being data for specifying the document data; and
deleting the document data from the memory when information indicating that the first specifying data matches second specifying data is received from the external apparatus, the second specifying data being data for specifying the document data received by the external apparatus,
wherein, when communication using HTTP is performed in the transmission of the document data to the external apparatus, the first specifying data is transmitted to the external apparatus.
